(19) United States
(12) Patent Application Publication
(10) Pub. No.: US 2012/0022749 A1
(43) Pub. Date: Jan. 26, 2012

(54) APPARATUS AND METHODS FOR ELIMINATING OR REDUCING BLIND SPOTS IN VEHICLE MIRROR AND CAMERA SYSTEMS

(76) Inventor: Thomas Clegg, Montoursville, PA (US)

(21) Appl. No.: 13/188,674

(22) Filed: Jul. 22, 2011

Related U.S. Application Data
(60) Provisional application No. 61/366,621, filed on Jul. 22, 2010.

(51) Int. Cl. G06F 17/00

(52) U.S. Cl. 701/49

(57) ABSTRACT

Provided herein are new apparatus and methods relating to mirror systems, including mirror systems for vehicles, including but not limited to automobiles, trucks, motorcycles, scooters, bicycles, all-terrain vehicles, motorized carts, among others. The apparatus and methods eliminate or reduce blind spots by facilitating a temporary desired adjustment of the mirror and/or camera, optionally followed by a return to the original position of the mirror and/or camera.

### CROSS REFERENCE TO RELATED APPLICATIONS

This application claims priority to U.S. Provisional Patent Application Ser. No. 61/366,621 filed on Jul. 22, 2010.

### FIELD OF THE INVENTION

This application describes apparatus and methods relating to mirror systems, including mirror systems for vehicles, including but not limited to automobiles, trucks, motorcycles, scooters, bicycles, all-terrain vehicles, motorized carts, among others.

### BACKGROUND OF THE INVENTION

Mirror systems are known for use by operators of vehicles of all types, as well as for non-mobile uses such as in safety and security systems in buildings, for example. For example, vehicles such as automobiles are known to have several mirrors provided to assist an operator or occupant in viewing areas around the vehicle without the need to turn one's head and/or body to directly view the desired area. In cars, it is common to provide as many as three mirrors to allow the driver to view objects beside and behind the vehicle. Typically, one mirror is provided one the outside of the driver's window, one is provided outside the passenger's window, and one is provided approximate the center of the windshield. It is known to make the outside mirrors adjustable by manual or motorized means. For example, many cars have a joystick-type apparatus mounted on the inner door panels to permit occupants to adjust the angle of the outside mirror. Some joysticks are direct mechanical links to the mirror. Still other joysticks are electrical switches electronically linked to a motor in the outside mirror, the motor mechanically attached to the mirror glass to facilitate adjustments received by the driver's movement of the joystick. Once adjusted to meet the needs of the driver or other occupant, the mirror remains fixed and continuously provides a view of a limited region of space beside or behind the vehicle.

In addition to mirrors, modern cars have included “back-up” camera systems that allow a driver to see an image of an area behind the car displayed on a screen. The camera is typically provided in proximity to the rear license plate, hatch, or trunk of the vehicle. The display screen may be fixed in the dashboard, or may be freestanding, such as by mounting on the windshield or dashboard by suction cup or other display screen support apparatus. Many cars with “back up” camera systems automatically activate the back-up camera and display screen when the vehicle transmission is placed in reverse mode.

Despite the existence of mirror systems and “back up” camera systems, a significant problem continues to exist with every vehicle in production. That problem is referred to as a “blind spot”—an area that cannot be viewed by the operator with the mirrors and/or cameras in the “set it and forget it” position selected by the driver or other occupant. Accordingly, a continuing and unmet need exists for new and improved apparatus and methods to eliminate or reduce “blind spots” during vehicle operation.

Every driver of a vehicle faces a potentially challenging situation every time an “on-ramp” is utilized to access a thruway (expressway). The vehicle operator is forced to locate a break in traffic while trying to view clearance for the merge in the outside mirror which provides virtually no help. The preset mirror creates a blind spot just at the point of merger. The traffic flowing from the thruway (rear, left) can be moving at a speed that makes it difficult to judge the appropriate time and spot to merge. Anxiety may be caused by the inability of each driver to make an instant decision to proceed or stop and wait. A driver can believe all is well because of the inadequacies of the outside mirror view bends around to the left taking eyes off the merging car in front. When the driver again looks forward, the car in front may have come to a dead stop, having lost confidence to merge. Rear-end collisions occur; following drivers hit guard rails, bridge abutments or other vehicles all to avoid the driver who failed to complete the merge. These physical gymnastics to see clearance for a merge, due to the blind-spot in the mirror, are even a greater problem for senior citizens due to their lack of flexibility and increased caution. However, highway traffic statistics are not gender or age specific.

The Departments of Motor Vehicles from nine available adjacent states (Ohio, PA, VA, MD, N.J., N.Y., W.V., ILL and IN) have provided statistics for the past three years '09, '08, '07 for “on ramp collisions”. The information provided by these states demonstrates and validates the thesis that there is a need to improve this outside mirror design. The National Department of Highway Safety Statistics released in a study completed in '07 states that a vehicle crash occurring between 6-9 miles per hour causes front end damage from $1,000-$5,000 depending on the make, model and age of the vehicle. This cost is absorbed by the insurance companies and passed on to the insurance consumers in the form of increased rates. Additional costs are the support services such as EMTs, Ambulances, Police and Firemen who have to show up at these incidents.

The automotive after-market has several novelty applications which do not resolve the problem but indicate a need for a greater solution to the problem. Stick-on and beveled after-market mirrors are found in automotive parts departments of dealerships, automotive after-market parts stores and super stores. It is the inventor's goal to rectify the causes of numerous injuries and deaths due to the ineffective design of vehicle outside mirrors, and the unreliable use of after-market mirrors. A further goal is to reduce automotive rear-end collisions 65% to 70% annually by use of the apparatus and methods described herein.

### SUMMARY OF THE INVENTION

Provided herein are new apparatus and methods for eliminating or reducing blind spots during operation of a vehicle by an operator. In some embodiments, an apparatus is provided for selectively adjusting the position of at least one rear view mirror or camera during vehicle operation. In an embodiment, the apparatus comprises at least one signal activation source, and at least one motor means communicably linked to the signal activation source, the motor means linked to the at least one mirror or camera, wherein a first activation of the signal activation source facilitates a first preselected movement of the mirror or camera. Optionally, the first preselected movement of the mirror or camera results in an increase in a vehicle operator's view of objects otherwise in the operator's blind spot.

In another embodiment, provided is an apparatus for selectively adjusting the position of at least one mirror and/or camera during vehicle operation, the apparatus comprising at least one signal activation source, and at least one motor means communicably linked to the signal activation source, the motor means linked to at least one mirror or at least one camera to facilitate at least one preselected movement of the mirror and/or camera, optionally followed by a return of the mirror and/or camera to an original position.

In other embodiments, methods of adjusting the position of at least one mirror and/or camera during vehicle operation are provided. In one example, the methods comprise the steps of activating at least one signal activation source to send a signal to at least one motor means communicably linked to the signal activation source, the motor means linked to at least one mirror or at least one camera, whereby the activation signal facilitates at least one preselected movement of the mirror and/or camera. Optionally, the method includes a return of the mirror or camera to an original position.

Additional features may be understood by referring to the accompanying drawings, which should be read in conjunction with the following detailed description and examples.

### BRIEF DESCRIPTION OF THE DRAWINGS

The present invention will hereinafter be described in conjunction with the appended drawing figures wherein like numerals denote like elements.

FIG. 1 schematically illustrates an exemplary blind spot viewing system in accordance with the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing FIGURE may be repeated in one or more subsequent figures without additional description in the specification in order to provide context for other features.

Provided herein are new apparatus and methods for eliminating or reducing blind spots during operation of a vehicle by an operator. For example, apparatus and methods are provided to permit an operator to selectively and temporarily adjust the mirror and/or camera viewing area to eliminate or reduce a blind spot that would otherwise result from the current “set it and forget it” position of the mirror and/or camera system. In an example, the apparatus provides for a selected motion of at least one mirror by a driver, the motion resulting in the elimination of a blind spot for a desired period of time, followed by a return to the original position of the mirror and/or camera.

In an apparatus example, the apparatus includes an electronically controlled mirror adjustment system. The system includes an activation signal that instructs an adjustment means, such as a motor means, to alter the position of at least one mirror and/or at least one camera. The activation signal may cause the adjustment means, such as an electric motor or any equivalent, to execute any number of movements and positions that are compatible with the adjustment means and a linked mirror and/or camera. For example: movement to a new position, followed by a pause for a predetermined period of time; slow movement through one or more positions, with or without pauses; continuous motion with return to the original position; and any combination thereof.

Preferably, the activation signal causes the motor to adjust the mirror and/or camera position to a preselected new position with a pause, the pause based upon the need that created mirror movement. For example, in a road condition involving a lane change, the activation signal would instruct the adjustment means, such as a motor, to quickly adjust the mirror(s) to view the blind spots on the side and rear of the car to view the lane space the operator seeks to enter. In one example, activation of a right turn signal would automatically serve as an activation signal for the motors controlling the right side, and optionally rear view, mirrors. Additionally or alternatively, the apparatus and system can include one or more dedicated activation signal switch(es) to allow a vehicle operator or occupant to send an activation signal to any or all mirrors at his/her whim.

In another working example, the inventor has noted that merge ramps are often the site of vehicle accidents. In states such as Pennsylvania, highway on-ramps are very short, and include very sharp curvature that limits the view of highway traffic to drivers of vehicles that seek to enter the highway. Quite simply, no outside mirror in a “set it and forget it” position can ever provide a vehicle operator driver with a safe view of highway traffic from every merge ramp, since ramps vary in curvature and length of merge. Many drivers crank down their windows and lean out, or otherwise perform driver seat gymnastics in an attempt to see the fast highway traffic approaching from behind and beside his/her vehicle. The apparatus and systems described herein can solve that problem. A driver seeking to improve his view of highway traffic would simply activate the activation signal switch (whether by activating a turn signal, activating one or more dedicated switches, or otherwise). In response to the signal, the motor controlling the mirror would move to a new position that provides an adequate view of the (now eliminated) blind spot. Preferably, the mirror would remain in that position until after a successful merge is completed. In that regard, the system can either require a second (return) activation signal, or can rely on a preset interval of time before return to the “set it and forget it” position. By way of non-limiting example, the second “return” activation signal can be triggered by the cancelling of the turn signal, return of driver wheel to a neutral position, the passing of a selected time, and/or by a pressing of an activation switch by an occupant of the vehicle, and/or by any number of combinations thereof.

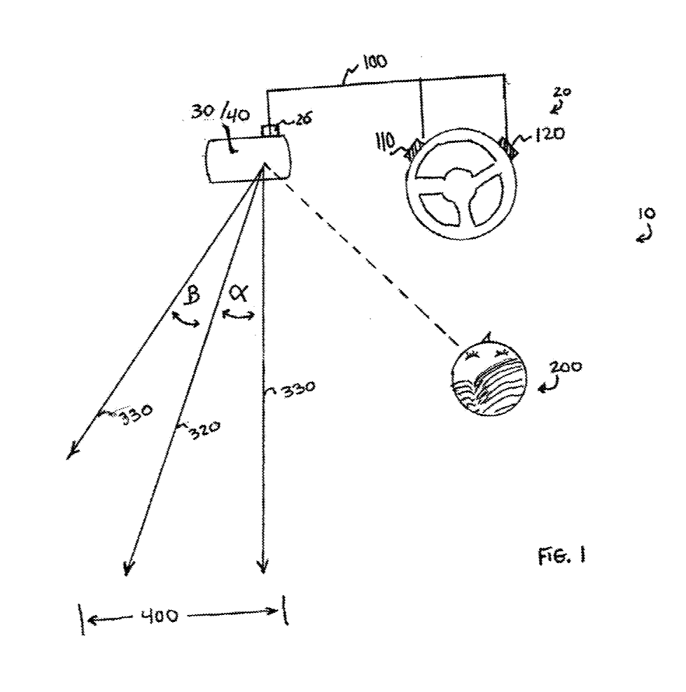

In one example, as shown in FIG. 1, the apparatus includes an electronically controlled mirror adjustment system 10. The system 10 includes an activation signal generator 120 that generates an activation signal 20 to travel, whether in a wire 100 or wirelessly, to control and/or instruct an adjustment means 26, such as a motor to alter the position of at least one mirror 130 and/or at least one camera 40. The activation signal may cause the adjustment means 26 to execute any number of movements and positions that are compatible with the adjustment means 26. For example: movement to a new position, followed by a pause for a predetermined period of time; slow movement through one or more positions, with or without pauses; continuous motion with return to the original position; and any combination thereof.

Preferably, the activation signal 20 causes the adjustment means 26 to adjust the mirror 30 and/or camera 40 position to a preselected new position with a pause, the pause based upon the user need that should be solved by the movement. For example, in a road condition involving a lane change, the activation signal would instruct the adjustment means 26 to quickly or rapidly adjust the mirror(s) 30 and/or camera 40 to view the blind spots on the side and rear of the car to view the lane space 400 the operator seeks to enter. In one example, activation of a right turn signal switch would automatically serve as the signal generator 120, thereby sending an activation signal 20 to a servo motor as adjustment means 26 controlling the right side, and optionally rear view 130, mirror(s) 30 or cameras 40. Additionally or alternatively, the apparatus and system 10 can include one or more dedicated activation signal switch(es) 110, 120 to allow a vehicle operator 200 or other occupant to send an activation signal to any or all mirrors 30 or cameras 40 at his/her whim. The movement of the adjustment means 26 and thereby moving the associated mirrors 30 and/or cameras 40 results in an adjustment of the line of sight angle from α to β, as shown in FIG. 1.

As discussed, after the line of sight 310, 320, 330 change need is resolved, the system 10 returns the mirror 30 and/or camera 40 to the original position, thereby restoring the sight angle to α, for example. It is contemplated that an infinite number of angle adjustments and movements therebetween can be made by the system 10 in any direction to adjust the line of sight angles to allow for viewing any area around a vehicle. For example, movement that involves tilting the mirror 30 and/or camera 40 can allow viewing of the curb in an area 400 for parking purposes. In one desirable embodiment, the apparatus is dynamic and in sync with an operator's normal driving movements. For example, using the turn signal switch as the activation signal source provides a seamless way of allowing a driver to activate the system at a time when viewing of objects next to or behind the car is critical. For example, turning on the left turn signal while waiting on a highway entrance ramp would activate the signal and send it to the adjustment means to adjust the mirror(s) and/or camera(s) on the left side of the vehicle to provide an image view of the blind spot otherwise present in that situation. Upon deactivation of the left turn signal, whether by an operator manually or automatically by the vehicle's steering mechanism (as incorporated in most modern automobiles), the motor means would return the mirror and/or camera to its original position. Notably, given the prevalence of electrically controlled mirrors in modern automobiles, the inventor has contemplated that the systems described herein can utilize existing mirror motors, and can be retrofitted to any vehicle having electrically adjustable mirrors. In such cases, an exemplary apparatus would include the installation of a signal activation source and means for programming or otherwise controlling the adjustment means to impart the desired movements of the mirrors at the desired times, as described herein. This example notes that no vehicle having electrically controlled mirrors allows a user to dynamically adjust the position of said mirrors through a single activation source as described herein.

As used herein, “adjustment means” can be any apparatus capable of altering the position, view, scanning area, reflection angle, or other image provided to a user by a mirror, camera, or other image-producing device compatible with use on or in a vehicle. By way of non-limiting example, “adjustment means” can include apparatus that physically alter the position of a mirror, lens or other image-producing device, such as servos, gears, wires, cables, and other physical positioning devices known in the art. By way of further non-limiting example, “adjustment means” includes apparatus, whether mechanical, electrical, optical (or combinations thereof) or otherwise, that achieve the desired effect of providing an image to a vehicle operator to mitigate or eliminate one or more blind spots, whether temporarily or permanently. By way of still further example, “adjustment means” can include any device that alters the refection angle, size, width, position, focus, zoom, or other image aspect of a camera or mirror of a vehicle to achieve any desired result stated herein.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

While the principles of the invention have been described above in connection with preferred embodiments, it is to be clearly understood that this description is made only by way of example and not as a limitation of the scope of the invention.

1. An apparatus for selectively adjusting the position of at least one mirror or camera during vehicle operation, the apparatus comprising at least one signal activation source, and at least one adjustment means communicably linked to the signal activation source, the motor means linked to the at least one mirror or camera, wherein a first activation of the signal activation source facilitates a first preselected movement of the mirror or camera.

2. The apparatus of claim 1, wherein the first preselected movement of the mirror or camera results in an image view of objects otherwise in the operator's blind spot.

3. The apparatus of claim 2, wherein the first preselected movement of the image area of the mirror or camera involves movement to provide a change of at least 5 degrees in the angle of view relative to the vehicle operator.

4. The apparatus of claim 2, wherein the first preselected movement of the mirror or camera involves movement to provide a change of between about 5 to about 20 degrees in the angle of view relative to the vehicle operator.

5. The apparatus of claim 1, wherein the first action of the signal activation source further facilitates a second preselected movement of the mirror or camera to a second position.

6. The apparatus of claim 2, wherein a second activation of the signal source facilitates at least one of: a pause of the mirror or camera movement, a third movement of the mirror or camera, movement of the mirror or camera to a desired position, return of the camera to its original position, and combinations thereof.

7. The apparatus of claim 2, wherein the activation of the signal source facilitates a pause of the mirror or camera in a predetermined position for a predetermined period of time between the first preselected movement and the second preselected movement.

8. The apparatus of claim 1, wherein the first preselected movement includes at least one of: intermittent movement, continuous movement, automatic return to the original position, and combinations thereof.

9. The apparatus of claim 1, wherein the signal activation source is at least one of a turn signal, mirror switch, steering wheel, steering mechanism, button, switch, and combinations thereof.

10. A method of adjusting the position of at least one mirror or camera during vehicle operation, the method comprising the step of activating at least one signal activation source to send a signal to at least one adjustment means communicably linked to the signal activation source, the adjustment means linked to at least one mirror or at least one camera, whereby the activation signal facilitates at least one preselected movement of the mirror or camera.

11. The apparatus of claim 10, wherein the first preselected movement of the mirror or camera results in an image view of objects otherwise in the operator's blind spot.

12. The apparatus of claim 11, wherein the first preselected movement of the mirror or camera provides a change of at least 5 degrees in the angle of view relative to the vehicle operator.

13. The apparatus of claim 10, wherein the first preselected movement of the mirror or camera provides a change of between about 5 to about 20 degrees in the angle of view relative to the vehicle operator.

14. The method of claim 10, wherein the step of activating further facilitates a second preselected movement of the mirror or camera to a second position.

15. The method of claim 10, further comprising the step of initiating a second activation of the signal source, wherein said step of initiating a second activation of the signal source facilitates at least one of: a pause of the mirror or camera movement, a third movement of the mirror or camera, movement of the mirror or camera to a desired position, return of the camera to its original position, and combinations thereof.

16. The method of claim 10, wherein an activation of the signal source facilitates a pause of the mirror or camera in a predetermined position for a predetermined period of time between the first preselected movement and the second preselected movement.

17. The method of claim 10, wherein the first preselected movement includes at least one of: intermittent movement, continuous movement, automatic return to the original position, and combinations thereof.

18. A blind spot mitigating system for a vehicle, the system comprising apparatus for selectively adjusting the position of at least one rear view mirror or camera during vehicle operation, the apparatus comprising at least one signal activation source, and at least one adjustment means communicably linked to the signal activation source, the motor means linked to the at least one rear view mirror or camera, wherein a first activation of the signal activation source facilitates a first preselected movement of the mirror or camera.

19. The apparatus of claim 1, wherein the first preselected movement of the mirror or camera results in an increase in a vehicle operator's view of objects otherwise in an operator's blind spot.

20. The apparatus of claim 2, wherein the first preselected movement of the mirror or camera provides a change of at least 5 degrees in the angle of view relative to the vehicle operator.
